(19) United States
(12) Patent Application Publication
(10) Pub. No.: US 2003/0189602 A1
(43) Pub. Date: Oct. 9, 2003

(54) Method and apparatus for browsing images in a digital imaging device

(76) Inventors: Dan L. Dalton, Greeley, CO (US); Paolo Fontani, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/117,414

(22) Filed: Apr. 4, 2002

(51) Int. Cl. G09G 5/00

(52) U.S. Cl. 345/830

(57) ABSTRACT

A digital imaging device user interface provides for the browsing of stored images using an intuitive virtual-stack-of-images metaphor. Images may be slid animatedly off or onto the virtual stack of images much as a user would flip through a stack of physical photographs. The user interface may be used in devices such as digital cameras, scanners, personal digital assistants, or palmtop computers.

### FIELD OF THE INVENTION

The present invention relates generally to digital imaging devices and, more specifically, to user interfaces for browsing images in such devices.

### BACKGROUND OF THE INVENTION

Digital imaging devices such as digital cameras and portable scanners are typically capable of storing large numbers of acquired digital images in nonvolatile memory. Other portable devices such as palmtop computers and personal digital assistants (PDAs) are also capable of image storage and retrieval. Browsing among a large number of images in a small device can be tedious unless a simple and intuitive user interface is provided.

Some digital imaging device user interfaces treat the browsing of stored images much like a slide show in which one image suddenly disappears, the display momentarily goes blank, and another image suddenly “flashes” onto the display. While efficient, such an approach does not provide feedback to aid the user in visualizing the three-dimensional aspects of browsing a group of images. It is thus apparent that there is a need in the art for an improved method and apparatus for browsing images in a digital imaging device.

### SUMMARY OF THE INVENTION

A method is provided for browsing a virtual stack of images. An apparatus for carrying out the method is also provided.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIGS. 1A and 1B are conceptual diagrams of a method for forward navigation in a virtual stack of images in accordance with an illustrative embodiment of the invention.

FIGS. 2A and 2B are conceptual diagrams of a method for reverse navigation in a virtual stack of images in accordance with an illustrative embodiment of the invention.

FIGS. 3A and 3B are conceptual diagrams of a method for forward navigation of a virtual stack of images by more than one image at a time in accordance with an illustrative embodiment of the invention.

FIGS. 4A and 4B are conceptual diagrams a method for reverse navigation of a virtual stack of images by more than one image at a time in accordance with an illustrative embodiment of the invention.

FIGS. 5A and 5B are conceptual diagrams of a variation of forward and reverse navigation, respectively, of a virtual stack of images in accordance with an illustrative embodiment of the invention.

FIG. 6 is a block diagram of a digital imaging device in accordance with an illustrative embodiment of the invention.

FIG. 7A is an illustration of a first type of input control for browsing a virtual stack of images in accordance with an illustrative embodiment of the invention.

FIG. 7B is an illustration of a second type of input control for browsing a virtual stack of images in accordance with another illustrative embodiment of the invention.

FIGS. 8A-8D are illustrations of different methods for animatedly sliding an image off or onto the display of a digital imaging device in accordance with an illustrative embodiment of the invention.

FIGS. 9A and 9B are a flowchart of the operation of the digital imaging device shown in FIG. 6 in accordance with an illustrative embodiment of the invention.

FIG. 10 is a flowchart of the operation of the digital imaging device shown in FIG. 6 in accordance with another illustrative embodiment of the invention.

FIG. 11 is a diagram of an illustrative method for modeling a virtual stack of images within the memory of the digital imaging device shown in FIG. 6.

### DETAILED DESCRIPTION OF THE INVENTION

Browsing images in a digital imaging device is facilitated by a “virtual-stack-of-images” metaphor in which the user interface mimics the manner in which a user would flip through a stack of physical photographs. Typically, people browse a stack of physical photographs by sliding one or more pictures from the top of the stack and placing them on the bottom or vice versa. In a digital imaging device, animation may be employed to simulate images being slid off or onto a virtual stack of images. Such an approach increases the “fun factor” of using the device and provides the user with helpful simulated 3D feedback that makes browsing large sets of images intuitive and comfortable.

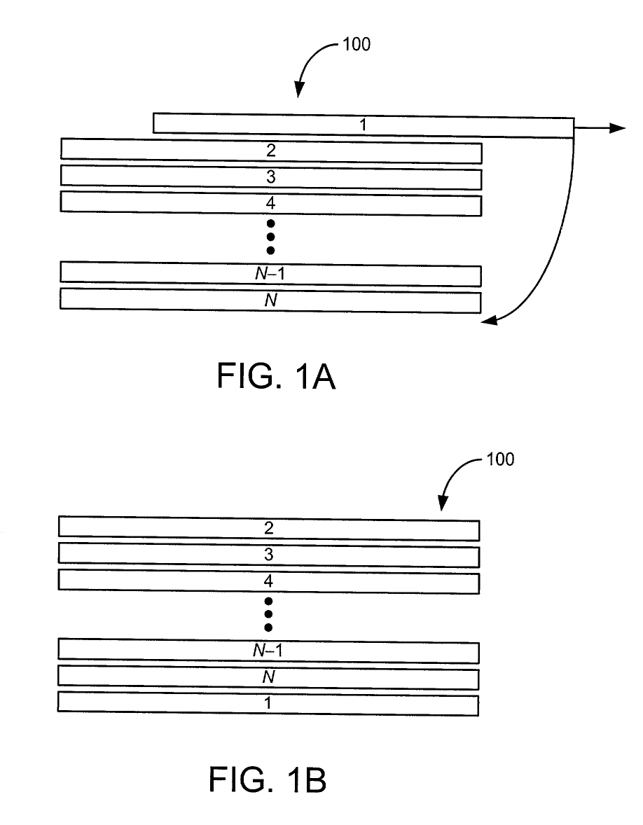

FIGS. 1A and 1B are conceptual diagrams showing a method for browsing through a virtual stack of images in the forward (downward from the top) direction in accordance with an exemplary embodiment of the invention. In FIGS. 1A and 1B, image 1 is “slid” off virtual stack of images 100 and placed on bottom. Throughout this description, “sliding” an image off or onto virtual stack of images 100 means animatedly moving that image off or onto virtual stack of images 100. Animation techniques are discussed in more detail later in this description.

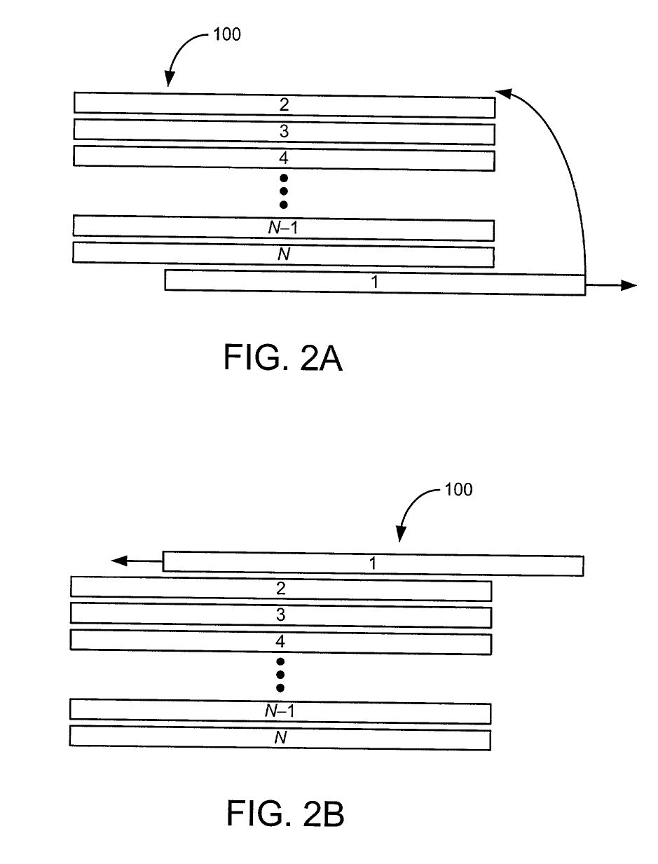

FIGS. 2A and 2B, analogous to FIGS. 1A and 1B, show the same process in reverse. In this case, image 1 is removed from the bottom of virtual stack of images 100 and slid onto the top in a direction opposite that in which image 1 was slid off in FIG. 1A.

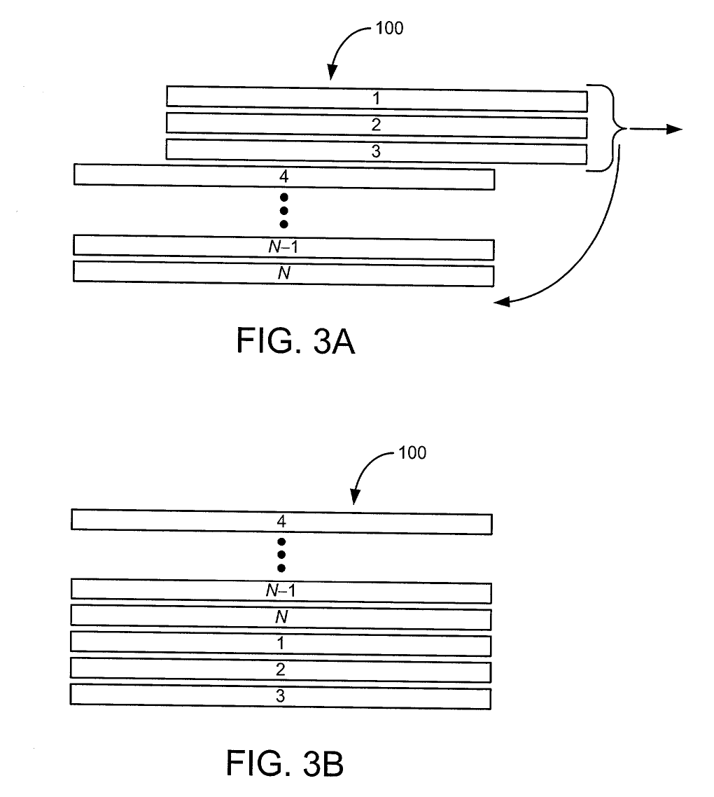

FIGS. 3A and 3B show a variation of FIGS. 1A and 1B in which more than one image at a time is slid off the virtual stack of images and placed on bottom. Since virtual stack of images 100 is an abstraction that is not subject to the limitations of a stack of physical photographs, the implementation of methods such as that shown in FIGS. 3A and 3B is simplified by techniques to be discussed later in this description.

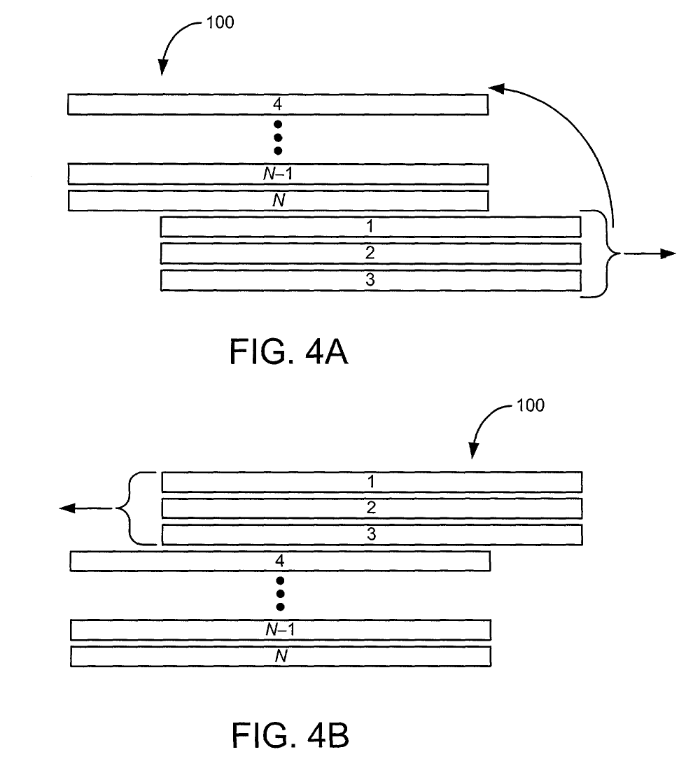

FIGS. 4A and 4B, analogous to FIGS. 3A and 3B, show the same process in reverse.

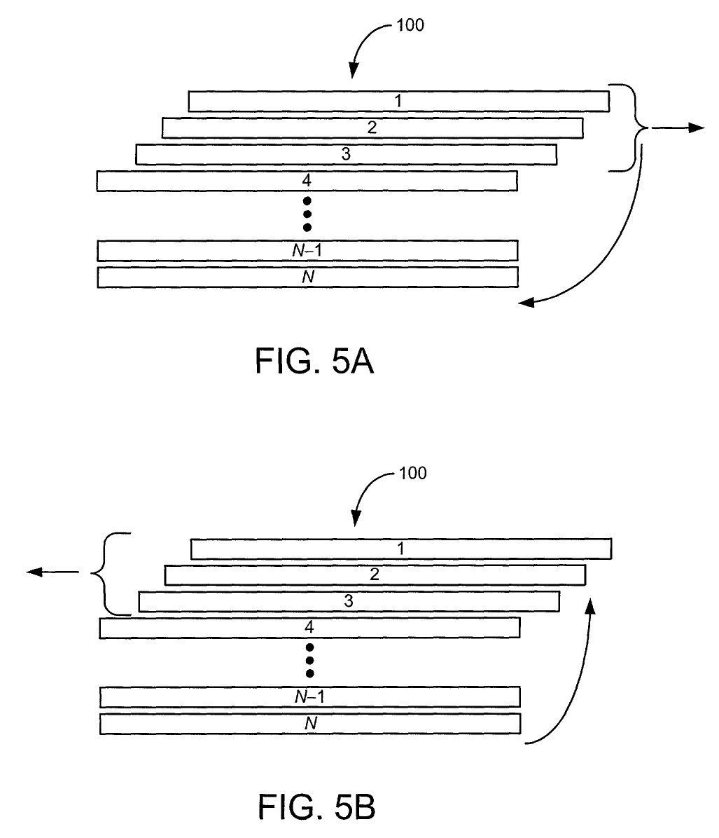

FIGS. 5A and 5B show a variation of the methods of FIGS. 3A and 4B, respectively, in which images 1, 2, and 3 are “fanned” as they are slid off or onto virtual stack of images 100. This simulates the effect of a user sliding several photographs simultaneously in overlapping fashion off or onto a stack of physical photographs. The utility of this variation will be explained more fully in a later portion of this description.

Those skilled in the art will recognize that virtual stack of images 100 may be abstracted and managed differently from the manner shown in FIGS. 1-5. For example, in FIGS. 1-5, the top image in virtual stack of images 100 is assumed to be the currently displayed image. In a different model, the currently displayed image could be the bottom image in the stack instead of the top, even though such a model does not correspond to the way a user would view a stack of physical photographs. Accordingly, the labels “top” and “bottom” are arbitrary and could easily be conceptualized as a “first end” and a “second end.” Also, in a variation of the foregoing methods, images may be slid onto virtual stack of images 100 in the same direction in which they are slid off instead of in the opposite direction as indicated in FIGS. 1-5.

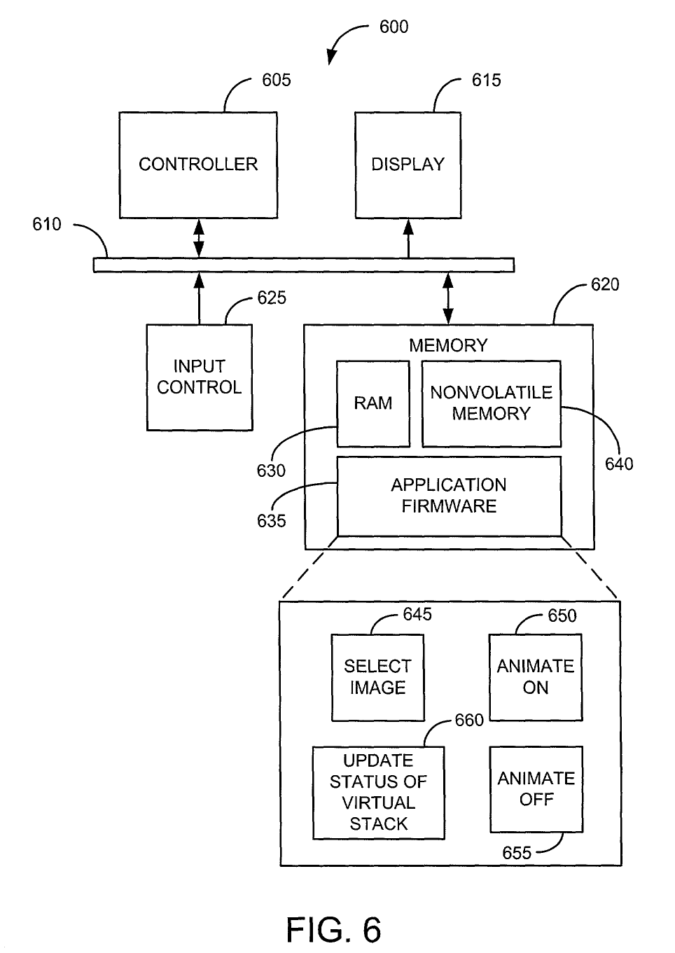

FIG. 6 is a block diagram of a digital imaging device 600 in accordance with an illustrative embodiment of the invention. Digital imaging device 600 may be a digital camera, digital scanner, personal digital assistant (PDA), palmtop computer, or any other device capable of displaying and navigating among stored digital images. In FIG. 6, controller 605 communicates over data bus 610 with display 615, memory 620, and input control 625. Memory 620 may further comprise random access memory (RAM) 630, application firmware 635, and nonvolatile memory 640. Nonvolatile memory 640 may store digital images to be browsed. Application firmware 635 may further comprise program instructions for selecting images from nonvolatile memory 640 (645), animatedly sliding an image onto virtual stack of images 100 (650), animatedly sliding an image off virtual stack of images 100 (655), and updating the status of virtual stack of images 100 to reflect simulated changes in position (660).

Display 615, in a typical implementation, is of the color liquid crystal display (LCD) variety. Images stored in nonvolatile memory 640 may be stored in the popular Exchangeable Image File (EXIF) format in which, for each photograph, both a full-resolution image and a lower resolution “thumbnail” image are stored. Since thumbnail images are much smaller than their fall-resolution counterparts, they may be used to advantage in implementing a virtual-stack-of-images user interface.

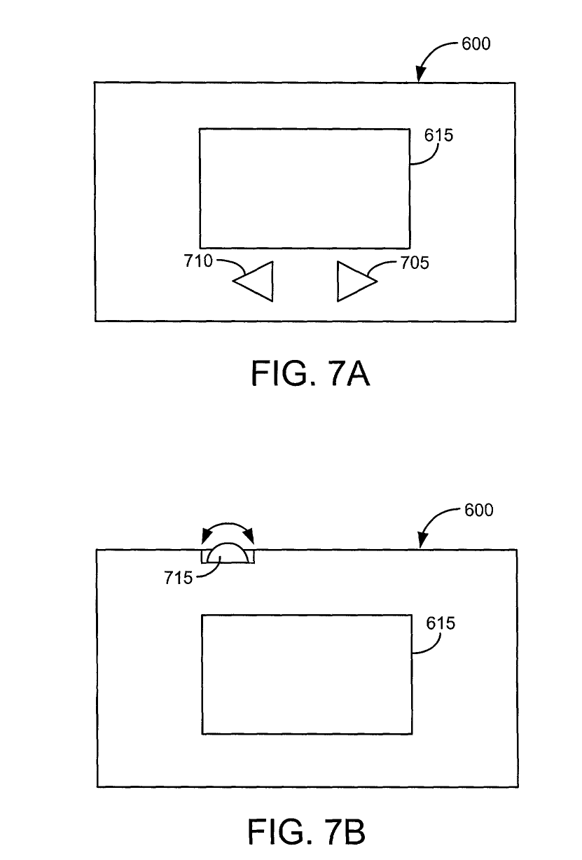

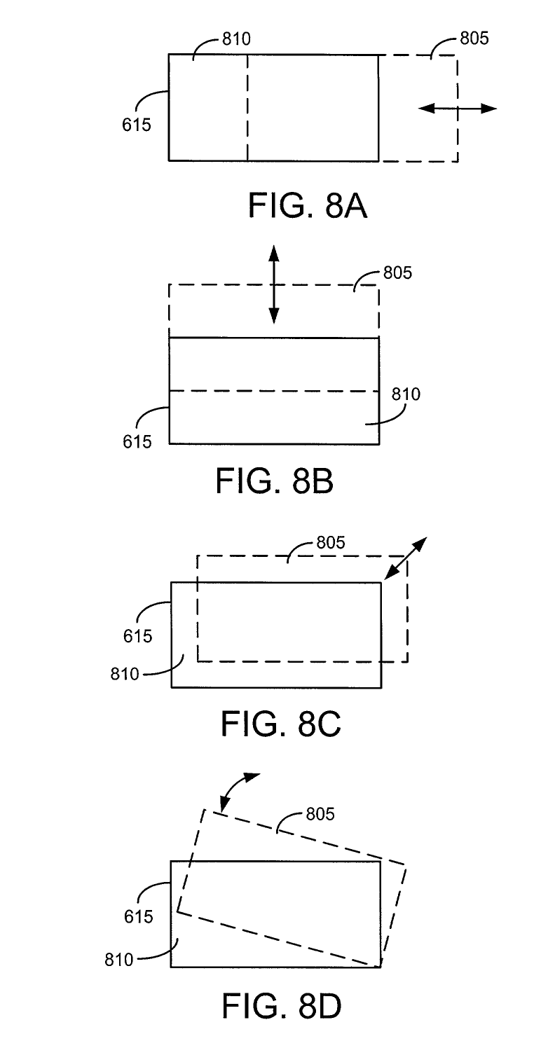

Input control 625 may be implemented in a variety of ways, two of which are shown in FIGS. 7A and 7B. In the example of FIG. 7A, digital imaging device 600 is a digital camera with display 615 on its reverse side. A user may navigate among virtual stack of images 100 using right button 705 and left button 710. In other implementations, the buttons may be oriented vertically instead of horizontally, or a single multi-position switch may be used. For the purposes of the invention, input control 625 need only generate two distinguishable signals to which controller 605 can respond.

In the example of FIG. 7B, rotary dial 715 is used to navigate among virtual stack of images 100. The rotation of rotary dial 715 may be quantized into discrete increments or “clicks” such that rotation by M increments corresponds to a change in position within virtual stack of images 100 of M images. Rotary dial 715 may be rotated in either of two senses, clockwise or counterclockwise, each of which corresponds to a distinct input signal. For the purposes of this description, rotation in the clockwise sense will be called the first signal, and rotation in the opposite sense will be called the second signal.

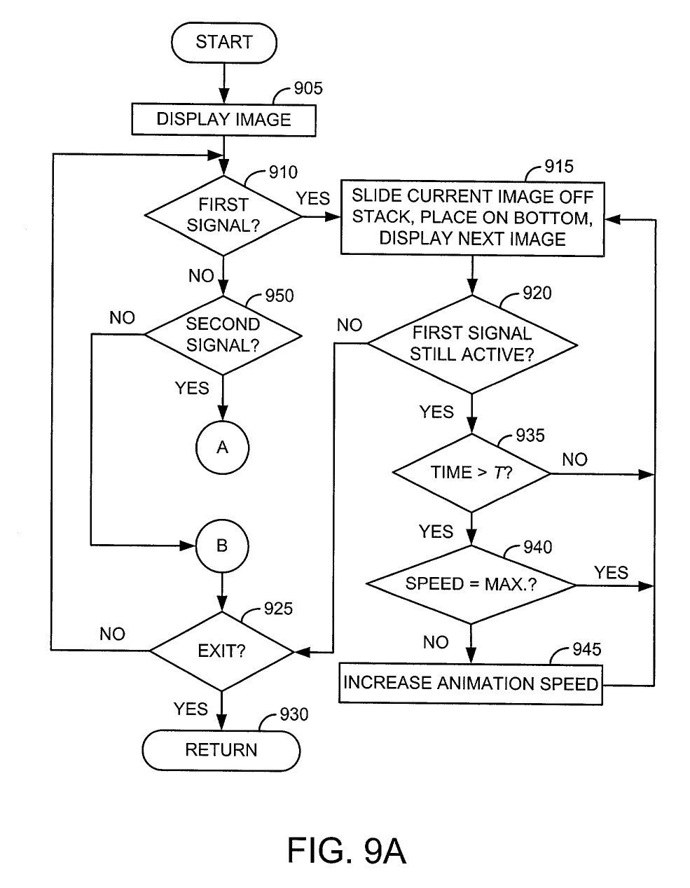

FIGS. 8A-8D illustrate various animation options that may be employed in sliding images off or onto virtual stack of images 100. Such animation techniques per se are well known in the art. Nominally, the top image of virtual stack of images 100 is assumed to be visible on display 615 in FIGS. 8A-8D. FIG. 8A depicts horizontal translation in which currently displayed image 805 is slid off virtual stack of images 100 to the right or onto virtual stack of images 100 to the left. As image 805 is slid off virtual stack of images 100, a static (non-animated) image 810 is gradually filled in vertical strip by vertical strip adjacent to the left edge of image 805 to create the illusion of static image 810 being uncovered by the translation of image 805. When image 805 is slid onto virtual stack of images 100, the opposite steps are performed, and static image 810 is gradually replaced, vertical strip by vertical strip, by image 805 to create the illusion that image 805 has covered image 810.

FIG. 8B depicts vertical translation in which currently displayed image 805 is slid off virtual stack of images 100 upwardly or onto virtual stack of images 100 downwardly. FIG. 8C depicts diagonal translation upward to the right and downward to the left. FIG. 8D depicts pivotal animation in which image 805 is rotated about an anchored comer (bottom right in this example). In all of the foregoing examples, the directions shown may be altered. For example, in FIG. 8A, translation could instead be off virtual stack of images 100 to the left and onto virtual stack of images 100 to the right. Also, the direction of sliding on may be the same as that of sliding off instead of opposite as indicated in FIGS. 8A-8D.

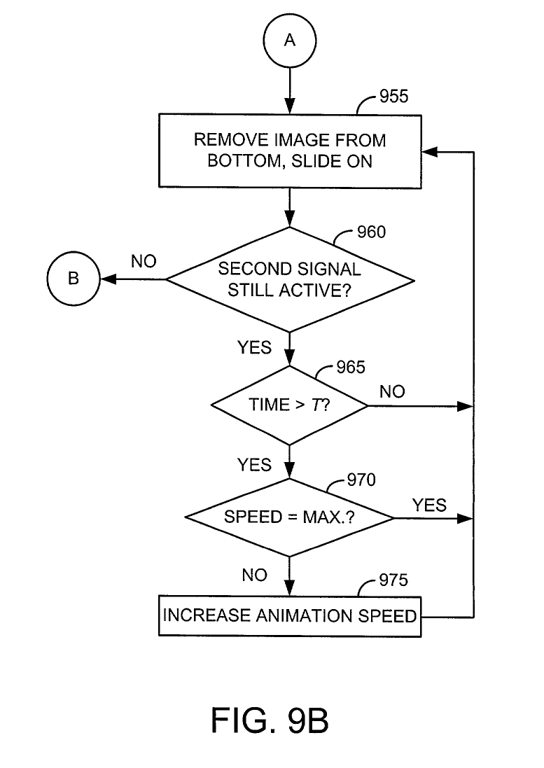

FIGS. 9A and 9B are a flowchart of the operation of digital imaging device 600 in accordance with an illustrative embodiment of the invention. In this particular embodiment, virtual stack of images 100 is arranged from an oldest (earliest created) image at the “top” of the stack to a newest image on “bottom.” In other embodiments, the reverse arrangement or some other desirable arrangement may be employed. At 905, digital imaging device 600 displays an image on display 615 upon entering an image browse mode. The first image displayed may be the oldest image just mentioned or, in a variation, the last image viewed by the user before image browse mode was last exited. If a first signal is received from right button 705 at 910, control proceeds to 915, where the currently displayed image is animatedly slid off virtual stack of images 100 on display 615. In this particular embodiment, animation is as indicated in FIG. 8A (off to the right, on to the left). Also at 915, virtual stack of images 100 is arranged such that the image that was just slid off virtual stack of images 100 is placed on bottom of the stack, and the next image in virtual stack of images is now visible as the new “top” image. If the first signal from right button 705 is no longer active at 920, control proceeds to 925. If a command is received at 925 to exit image browse mode, the mode is terminated at 930. Otherwise, if the first signal from right button 705 is still active at 920, control proceeds to 935, where the elapsed time since right button 705 was first pressed is determined. If that time exceeds a predetermined period T, control proceeds to 940. Otherwise, control returns to 915. At 940, the current animation speed is compared to the maximum possible animation speed. If the current speed is less than the maximum, the animation speed is increased at 945. Otherwise, if the animation speed is already at maximum, control returns to 915. The loop comprising steps 915, 920, 935, 940, and 945 implements an autorepeat mode in which continually pressing right button 705 causes virtual stack of images to advanced image by image at a gradually accelerating speed until the maximum supported animation speed of digital imaging device 600 is reached. Optionally, the autorepeat loop may terminate automatically whenever the nominal bottom image in virtual stack of images 100 is reached. In this illustrative embodiment, that image would be the newest image in the stack. This aids the user in keeping track of where he or she is in virtual stack of images 100.

If the first input signal is not received at 910, control proceeds to 950. If a second signal from left button 710 is received at 950, control proceeds to 955 in FIG. 9B. Otherwise, control proceeds to “B” (925 in FIG. 9A). At 955, the bottom image in virtual stack of images 100 is “removed,” and that image is slid onto virtual stack of images 100 on display 615 from right to left as in FIG. 8A, the image thereby becoming the new top image in the stack. The previously displayed image is designated as the second image from the top of the stack. If the second signal from left button 710 is no longer active at 960, control proceeds to “B” (925 in FIG. 9A). Otherwise, control proceeds to 965. Steps 965, 970, and 975, which are analogous to steps 935, 940, and 945, respectively, comprise part of an autorepeat loop in the reverse direction. Optionally, the autorepeat loop comprising steps 955, 960, 965, 970, and 975 may terminate automatically whenever the nominal top (oldest) image in virtual stack of images 100 is reached.

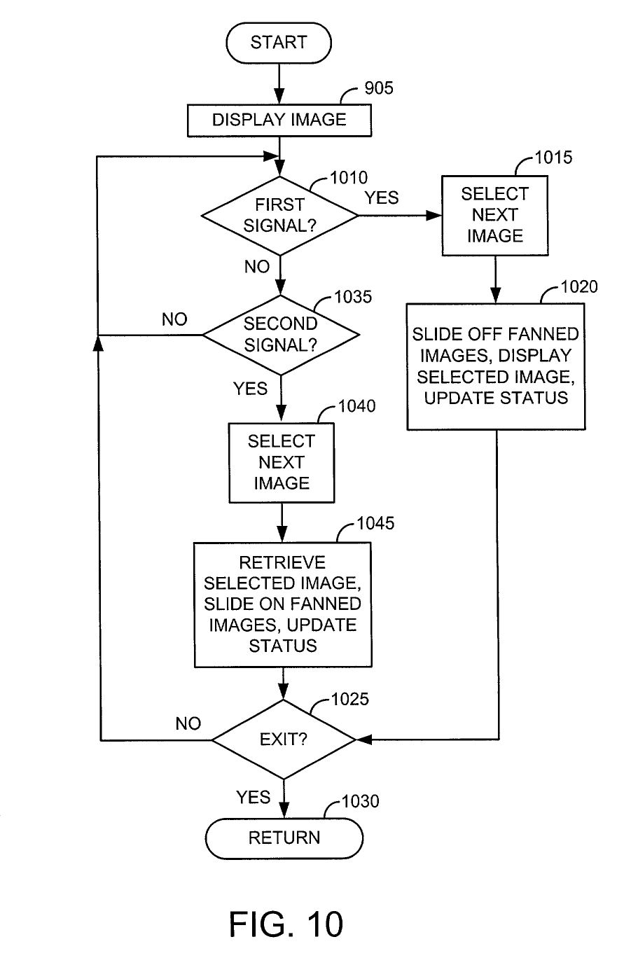

FIG. 10 is a flowchart of the operation of digital imaging device 600 in accordance with another illustrative embodiment of the invention. In this particular embodiment, rotary dial 715 generates first and second signals to control image navigation as explained in connection with FIG. 7B. At 905, digital imaging device 600 displays an image on display 615 upon entering image browse mode. If the first signal (clockwise rotation of rotary dial 715) is received at 1010, the next image to be displayed on display 615 is selected at 1015. In this case, selection is from the top of virtual stack of images 100 downward in the stack (forward navigation). Each increment of rotary dial 715 corresponds to a change in position of one image in virtual stack of images 100, and the image selected at 1015 is determined from the number of increments by which rotary dial 715 is rotated. Optionally, display 615 may include textual indexing information such as “M/N” to indicate that image M of N images in virtual stack of images 100 is currently displayed. When the first signal is received at 1010, the index may be changed from “M/N” to “K/N” to indicate the next image that will be displayed after the current image is animatedly slid off virtual stack of images 100. At 1020, the currently displayed image and all other images between that image and the selected image may be fanned as indicated in FIG. 5A and slid off virtual stack of images 100 to the right on display 615. Fanning the images provides the user with visual confirmation that one or more images in virtual stack of images 100 have been skipped in selecting the next image. Once the fanned images have been slid off virtual stack of images 100, the selected image is displayed on display 615, and the status of virtual stack of images 100 is updated to reflect the new relative positions of the images within the stack. If a request to exit image browse mode is received at 1025, the mode is terminated at 1030. If the first signal was not received at 1010, control proceeds to 1035. If the second signal (counterclockwise rotation of rotary dial 715) is received at 1035, the next image to be displayed is selected at 1040. In this case, however, selection is in the reverse direction, from the bottom of virtual stack of images 100 upward instead of from the top downward. At 1045, the selected image, along with all other images between that image and the bottom image in the stack, inclusive, are fanned as indicated in FIG. 5B and slid onto virtual stack of images 100 from right to left on display 615. Also, the status of virtual stack of images is updated to reflect the new relative positions of the images within the stack.

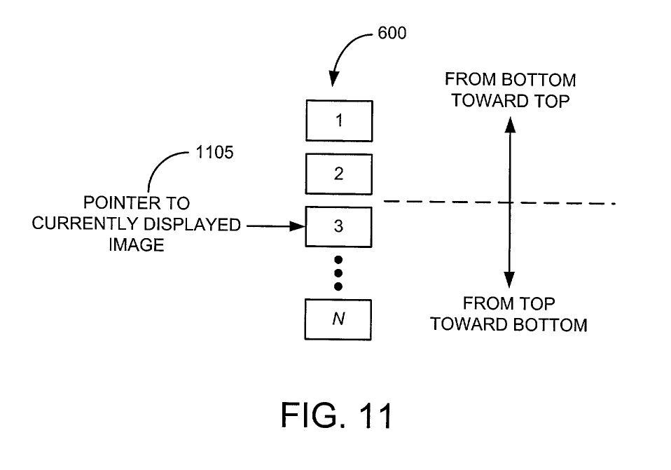

FIG. 11 is a diagram of an illustrative method for modeling virtual stack of images 100 within nonvolatile memory 640 of digital imaging device 600. Although virtual stack of images 100 may mimic the conceptual model of FIGS. 1-5 in which images are moved within the stack, no physical movement or rearranging of images is necessary in a computer implementation. In fact, a simple pointer to a location in nonvolatile memory 640 may be sufficient for some implementations. In FIG. 11, pointer 1105 stores the starting address of the currently displayed image in virtual stack of images 100. In this example, image 3 is currently displayed and represents the “top” of the stack. Image 2 may be considered the “bottom” image in the stack, and image 1, the second image from the bottom. Moving toward higher memory, image 4 may be considered the second image from the top, and so forth. Selecting a different picture for display requires simply updating pointer 1105 accordingly, and the relationships among the images in virtual stack of images 100 are correspondingly updated. The approach shown in FIG. 11 is just one of many possible ways of modeling a stack of physical photographs in memory.

The foregoing description of the present invention has been presented for the purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for browsing a virtual stack of images, the virtual stack of images having a first end and a second end, the method comprising the steps of:
(a) displaying the virtual stack of images on a display, a first image being fully visible and occupying the first end;
(b) animatedly sliding the first image off the virtual stack of images in a first direction in response to a first input signal, a static second image becoming progressively visible as the first image is slid off the virtual stack of images, the static second image occupying the first end upon becoming fully visible; and
(c) placing the first image at the second end.

2. The method of claim 1, further comprising:
(d) removing the first image from the second end; and
(e) animatedly sliding the first image onto the virtual stack of images in a direction opposite the first direction in response to a second input signal, the static second image becoming progressively obscured as the first image is slid onto the virtual stack of images, the first image occupying the first end upon becoming fully visible.

3. The method of claim 2, wherein the first input signal comprises rotating a dial in a first sense and the second input signal comprises rotating the dial in a second sense opposite the first sense.

4. The method of claim 2, wherein the first input signal comprises pressing a first button, and the second input signal comprises pressing a second button.

5. The method of claim 4, further comprising:
repeating steps (a) through (c) automatically for successive images in the stack of virtual images in response to a continual press of the first button until a last image in the virtual stack of images is displayed.

6. The method of claim 5, wherein the rate at which steps (a) through (c) are performed accelerates to a predetermined maximum rate after the first button has been pressed continually for a predetermined period.

7. The method of claim 4, further comprising:
repeating steps (d) and (e) automatically for precedent images in the stack of virtual images in response to a continual press of the second button until an initial image in the virtual stack of images is displayed.

8. The method of claim 7, wherein the rate at which steps (d) and (e) are performed accelerates to a predetermined maximum rate after the second button has been pressed continually for a predetermined period.

9. The method of claim 2, wherein step (d) comprises modifying a pointer to a memory.

10. The method of claim 1, wherein step (c) comprises modifying a pointer to a memory.

11. The method of claim 1, wherein the first direction is horizontal, vertical, diagonal, or pivotal.

12. The method of claim 1, wherein the virtual stack of images is arranged chronologically from an earliest-created image to a most recently created image.

13. A method for browsing a virtual stack of images, the virtual stack of images having a first end and a second end, the method comprising the steps of:
(a) displaying the virtual stack of images on a display, a first image being fully visible and occupying the first end;
(b) selecting a static second image by rotating a dial in a first sense;
(c) identifying a first set of images comprising the first image and the images between the first image and the static second image, the remaining images in the virtual stack of images comprising a second set of images; and
(d) interchanging the order of the first and second sets of images, the first set of images being animatedly slid off the virtual stack of images in a first direction, the static second image becoming progressively visible as the first set of images is slid off the virtual stack of images, the static second image occupying the first end upon becoming fully visible.

14. The method of claim 13, further comprising:
(e) selecting a third image by rotating the dial in a sense opposite the first sense;
(f) identifying a third set of images comprising the third image through the image occupying the second end, the remaining images in the virtual stack of images comprising a fourth set of images;
(g) interchanging the order of the third and fourth sets of images, the third set of images being animatedly slid onto the virtual stack of images in a direction opposite the first direction, the static second image becoming progressively obscured as the third set of images is slid onto the virtual stack of images, the third image occupying the first end upon becoming fully visible.

15. The method of claim 13, wherein rotation of the dial is quantized into discrete increments, each discrete increment corresponding to a change in position of one image in the virtual stack of images, the images in the first set are fanned during step (c), and the fanned images in the first set are animatedly slid off the virtual stack of images during step (d), when the dial is rotated in the first sense by greater than one increment.

16. The method of claim 13, wherein step (d) comprises modifying a pointer to a memory.

17. The method of claim 14, wherein rotation of the dial is quantized into discrete increments, each discrete increment corresponding to a change in position of one image in the virtual stack of images, the images in the third set are fanned during step (f), and the fanned images in the third set are animatedly slid off the virtual stack of images during step (g), when the dial is rotated in the second sense by greater than one increment.

18. The method of claim 14, wherein step (g) comprises modifying a pointer to a memory.

19. A digital imaging device, comprising:
a memory to store a virtual stack of images, the virtual stack of images having a first end and a second end;
a display to display at least a first image occupying the first end;
an input control; and
first control logic configured to slide the first image animatedly off the virtual stack of images in a first direction in response to a first signal from the input control, a static second image becoming progressively visible as the first image is slid off the virtual stack of images, and to place the first image at the second end, the static second image occupying the first end upon becoming fully visible.

20. The digital imaging device of claim 19, further comprising second control logic configured to remove the first image from the second end and to slide the first image animatedly onto the virtual stack of images in a direction opposite the first direction in response to a second signal from the input control, the static second image becoming progressively obscured as the first image is slid onto the virtual stack of images, the first image occupying the first end upon becoming fully visible.

21. The digital imaging device of claim 20, wherein the input control comprises a dial, the first signal comprises a rotation of the dial in a first sense, and the second signal comprises a rotation of the dial in a second sense opposite the first sense.

22. The digital imaging device of claim 20, wherein the input control comprises a first button and a second button, the first signal comprising a press of the first button, the second signal comprising a press of the second button.

23. The digital imaging device of claim 20, wherein each of the first control logic and the second control logic includes an autorepeat mode that is activated when the first button or second button, respectively, is pressed continually.

24. The digital imaging device of claim 23, wherein the rate at which each autorepeat mode operates accelerates to a predetermined maximum rate after a predetermined period.

25. The digital imaging device of claim 23, wherein the autorepeat mode associated with each of the first control logic and the second control logic terminates when a last image or an initial image, respectively, in the virtual stack of images is displayed.

26. The digital imaging device of claim 19, wherein the first direction is horizontal, vertical, diagonal, or pivotal.

27. The digital imaging device of claim 19, wherein the virtual stack of images is arranged chronologically from an earliest-created image to a most recently created image.

28. The digital imaging device of claim 19, wherein the digital imaging device is a digital camera, a scanner, a personal digital assistant, or a palmtop computer.

29. A digital imaging device, comprising:
a memory to store a virtual stack of images, the virtual stack of images having a first end and a second end;
a display to display at least a first image occupying the first end;
a dial configured to select a static second image, when rotated in a first sense;
first control logic configured to
identify a first set of images and a second set of images, the first set comprising the first image and the images between the first image and the static second image, the second set comprising the remaining images in the virtual stack of images; and
interchange the order of the first and second sets of images, the first set of images being animatedly slid off the virtual stack of images in a first direction, the static second image becoming progressively visible as the first set of images is slid off the virtual stack of images, the static second image occupying the first end upon becoming fully visible.

30. The digital imaging device of claim 29, wherein the dial is configured to select a third image, when rotated in a sense opposite the first sense, and further comprising:
second control logic configured to
identify a third set of images and a fourth set of images, the third set comprising the third image through the image occupying the second end, the fourth set comprising the remaining images in the virtual stack of images; and
interchange the order of the third and fourth sets of images, the third set of images being animatedly slid onto the virtual stack of images in a direction opposite the first direction, the static second image becoming progressively obscured as the third set of images is slid onto the virtual stack of images, the third image occupying the first end upon becoming fully visible.

31. The digital imaging device of claim 29, wherein rotation of the dial is quantized into discrete increments, each discrete increment corresponding to a change in position of one image in the virtual stack of images, and the first control logic is configured to fan the images in the first set as the first set is being animatedly slid off the virtual stack of images, when the dial is rotated in the first sense by greater than one increment.

32. The digital imaging device of claim 30, wherein rotation of the dial is quantized into discrete increments, each discrete increment corresponding to a change in position of one image in the virtual stack of images, and the second control logic is configured to fan the images in the third set as the third set is being animatedly slid onto the virtual stack of images, when the dial is rotated in the second sense by greater than one increment.

33. A digital imaging device, comprising:
means for storing a virtual stack of images, the virtual stack of images having a first end and a second end;
display means for displaying at least a first image occupying the first end;
means for generating input signals; and
first logic means for sliding the first image off the virtual stack of images in a first direction in response to a first signal from the means for generating input signals, a static second image becoming progressively visible as the first image is slid off the virtual stack of images, and for placing the first image at the second end, the static second image occupying the first end upon becoming fully visible.

34. The digital imaging device of claim 33, further comprising second logic means for removing the first image from the second end and for sliding the first image animatedly onto the virtual stack of images in a direction opposite the first direction in response to a second signal from the means for generating input signals, the static second image becoming progressively obscured as the first image is slid onto the virtual stack of images, the first image occupying the first end upon becoming fully visible.

35. The digital imaging device of claim 34, wherein the means for generating input signals comprises a dial, the first signal comprises rotation of the dial in a first sense, and the second signal comprises rotation of the dial in a second sense opposite the first sense.

36. The digital imaging device of claim 34, wherein the means for generating input signals comprises a first button and a second button, the first signal comprising a press of the first button, the second signal comprising a press of the second button.

37. The digital imaging device of claim 33, wherein the first direction is horizontal, vertical, diagonal, or pivotal.

38. The digital imaging device of claim 33, wherein the virtual stack of images is arranged chronologically from an earliest-created image to a most recently created image.

39. The digital imaging device of claim 33, wherein the digital imaging device is a digital camera, a scanner, a personal digital assistant, or a palmtop computer.

40. A digital imaging device, comprising:
means for storing a virtual stack of images, the virtual stack of images having a first end and a second end;
display means for displaying at least a first image occupying the first end;
means for selecting a static second image;
first logic means for
identifying a first set of images and a second set of images, the first set comprising the first image and the images between the first image and the static second image, the second set comprising the remaining images in the virtual stack of images;
interchanging the order of the first and second sets of images, the first set of images being animatedly slid off the virtual stack of images in a first direction, the static second image becoming progressively visible as the first set of images is slid off the virtual stack of images, the static second image occupying the first end upon becoming fully visible.

41. The digital imaging device of claim 40, further comprising:
means for selecting a third image;
second logic means for
identifying a third set of images and a fourth set of images, the third set of images comprising the third image through the image occupying the second end, the fourth set comprising the remaining images in the virtual stack of images;
interchanging the order of the third and fourth sets of images, the third set of images being animatedly slid onto the virtual stack of images in a direction opposite the first direction, the static second image becoming progressively obscured as the third set of images is slid onto the virtual stack of images, the third image occupying the first end upon becoming fully visible.
